(19) United States
(12) Patent Application Publication
(10) Pub. No.: US 2009/0216459 A1
(43) Pub. Date: Aug. 27, 2009

(54) Ultrasonic System for Grading Meat Tenderness

(75) Inventors: David Goldberg, Boulder, CO (US); Wesley Cobb, Highlands Ranch, CO (US)

Correspondence Address: SWANSON & BRATSCHUN, L.L.C., 8210 SOUTHPARK TERRACE, LITTLETON, CO, 80120, US

(73) Assignee: COLORADO SEMINARY, Denver, CO (US)

(21) Appl. No.: 12/094,553

(22) PCT Filed: Nov. 20, 2006
(86) PCT No.: PCT/US06/61079

§ 371 Date: Jan. 5, 2009

Related U.S. Application Data
(60) Provisional application No. 60/739,312, filed on Nov. 22, 2005.

(51) Int. Cl. G06F 19/00

(52) U.S. Cl. 702/19

(57) ABSTRACT

Meat tenderness is determined by analyzing backscattered ultrasound signals. A signal envelope function computed from the backscattered ultrasound signals is used to derive a number of different parameters, which comprise a unimodal decay factor, a bimodal decay factor, a quiescence time, an event frequency parameter, and an event asymmetry index. Two or more of these factors are combined using a decision algorithm, which can be a neural network, a fuzzy logic classifier, a Bayesian classifier, a regression, an instance-based classifier, a decision tree, or a learned rule. These methods can also be applied to determine characteristics of the physiology of a live organism.

### TECHNICAL FIELD

The present invention relates to the grading of meat tenderness using analysis of ultrasound backscatter energy.

### BACKGROUND

The beef industry would strongly benefit from an objective measure of tenderness that can be used to establish the value of a carcass, and assist cattlemen in breeding better stock. Such a measure will eventually improve the quality of all beef being sold, and increase consumer's satisfaction with beef products. A number of recent consumer tests confirm that there is a strong preference for a tender steak.

Current methods of measuring beef tenderness include shear tests (e.g. the Warner-Bratzler Shear test—WBS, or the Slice Shear Force test—SSF), ultrasound measurement, meat color measurement (e.g. U.S. Pat. No. 6,198,834 to Belk, et al), and genetic tests for a variant of the calpastatin gene that correlates with meat tenderness. However, each of these tests suffer from at least one of the problems or high cost, long duration of test, low accuracy and destruction of the meat samples.

The ultrasound measurement system of U.S. Pat. No. 6,167,759 to Bond, Kishoni, and Mahrer represents a convenient approach to the measurement of meat tenderness. This invention uses analysis of backscatter energy from ultrasound transducers to indicate meat tenderness, and in particular, uses the decay constant of an exponential decrease in energy as the primary indicator of tenderness. This methodology has many benefits, including the rapidity and low cost of the test. The accuracy of the measurements from this system is, however, insufficient for a commercially viable test.

Having a measurement system that overcame these disadvantages would be of substantial benefit to the beef and other meat industries.

### BRIEF DESCRIPTION OF THE DRAWINGS

FIG. 1 is a cross-section of transducer locations within a sensor.

FIG. 2A is a graph of an envelope function with bimodal exponential decay.

FIG. 3B is a graph of the logarithm of the envelope function of FIG. 1A.

FIG. 4 is a graph of an envelope function exhibiting quiescence.

FIG. 5 is a graph of an envelop function exhibiting asymmetrical events.

### DETAILED DESCRIPTION OF THE INVENTION

### Overview

The present invention, like the invention of Bond et al, uses the backscatter of ultrasound energy to determine meat tenderness. One of the ways that the present invention, however, is distinguished from the prior art is in terms of the analysis of the backscatter energy.

The prior art used primarily a single measure—that of the decay constant of the exponential decrease in reflected energy—to determine meat tenderness. The present invention, however, uses other parameters of the reflected energy. Furthermore, the use of more than one parameter in conjunction with one another provides significant improvements in system accuracy. The use of multiple parameters generally requires within the present invention a decision algorithm to decide the way in which those parameters should be combined to yield an accurate result.

### Data Collection

The ultrasound back-scatter data can be obtained in a manner similar to that of Bond, et al, using similar energies and frequencies. Instead of using a single transducer, however, a multiplicity of transducers is conveniently used, so that data from different sites on the meat can be sampled in rapid succession without need for the transducer to be manually positioned between readings. The number of transducers simultaneously employed is preferably greater than or equal to 4 transducers, and more preferably greater than or equal to 8 transducers, and most preferably more than 12 transducers. A set of transducers that act together to generate data for measurement of meat tenderness is called a “sensor”.

The transducers can be arranged in a variety of patterns according to the present invention, including a linear array, a curved array (in the form of an arc), or a packed array, such as a hexagonally packed array or a rectangular array. It should be noted that the muscle surface exposed in meat grading is roughly ellipsoidal in nature, which makes a packed array that is consistent with the shape of the exposed meat very convenient.

These transducers are preferably distributed over an area smaller than that exposed during the process of meat grading in a meat packing operation, such as the cut that is generally made between the 12^{th} and 13^{th} ribs of a beef carcass. In such case, the entire transducer assembly can be placed onto the exposed face of the meat at one time, and signals from the multiplicity of transducers obtained in rapid succession.

It is further convenient for the transducers to be arranged within the assembly so that each transducer is positioned preferably roughly normal to the fiber directions of the meat, since non-normal orientation tends to reduce the amount of backscatter energy that is recorded by the transducer and influences the decay rate of the backscattered energy, which is a key parameter of the analysis. It should be understood that because of different sound velocities in the meat and the matrix compound in which the transducers are conveniently embedded in the assembly (such as an RTV rubber), and furthermore that the cut made during the grading process is at roughly a 45° angle with respect to the muscle fibers, that the angle of the transducer faces with respect to the assembly face will be approximately 45°. That is, the sound waves emanating from the transducer will cross the border between the meat and the assembly at roughly 45°, during which time their direction will change somewhat due to refraction of the sound energy. The degree of refraction is dependent on many factors, including the velocity of sound in the matrix material relative to that of the velocity of sound in meat, as well as other factors related to the emplacement of the transducers in the assembly matrix. The optimal angle of the transducers with respect to the assembly face can be determined either empirically, or roughly using Snell's Law if the approximate velocities of sound of the matrix and meat are known. It is an object of this orientation that the wavefront of the ultrasound energy travels in a direction that is preferably greater than 60° from the fiber direction, and even more preferably greater than 75° from the fiber direction, and most preferably that it is greater than 80° from the fiber direction.

Data is obtained from the different transducers within the assembly, each representing different volumes of meat. It should be noted that the transducers can be arranged in the form of an array which can be rectangular, hexagonal, or other arrangement, that allows the sound energy to be steered into the meat in different directions by changing the phases of the excitation of the transducers. In such case, in order to determine the optimal direction for steering, a number of different directions can be chosen, and the direction that yields the highest backscatter energy (and in particular, that backscatter energy in the fitted envelope function, as described below) is then chosen, since this is known to be approximately in the proper direction.

In addition, it is convenient to obtain other information about the meat that is being tested, wherein such information can comprise the age of the animal prior to slaughter, the breed of animal (e.g. Angus, Hereford), other aspects of the genetics of the animal, the grade and/or yield of the meat, the body mass index (BMI) of the animal, and tenderization processes used on the meat (e.g. aging) or other measure.

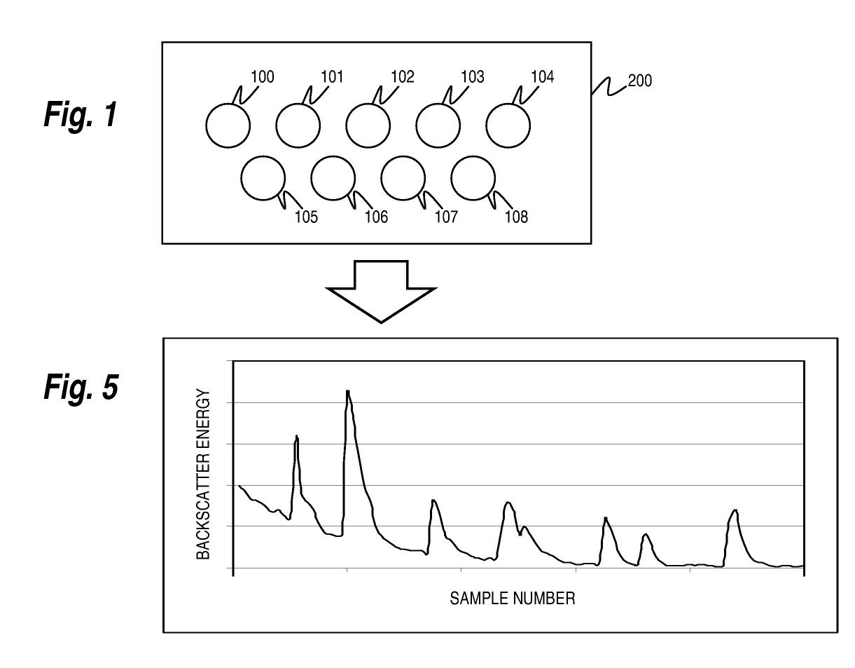

A preferred arrangement of transducers in a sensor is presented in FIG. 1, a cross-section of transducer 100-108 locations within a sensor 200. The nine transducers 100-108 are laid out in two arrays in order to obtain areal coverage of the meat, and the transducers are oriented, as described above, at approximately 45 degrees to the plane at which the transducers touch the meat. In this case, the transducers 100-108 are oriented in the plane of the paper 45 degrees in the direction of the arrow, so that meat in the direction of the arrow is sampled by the sensor 200. The spacing of the transducers 100-108 can be tight (e.g. the transducers nearly touching or touching), or alternatively, may have significant spacing, as shown in FIG. 1.

It should be noted that the transducers 100-108 do not need to be operated solely in pulse-echo mode, in which backscatter signal from a transducer is received by that same transducer. Indeed, it is preferable to additionally collect pitch-catch information, in which the energy emitted form one transducer is accepted by another transducer. For example, in FIG. 1, as a transmitter, the transducer 102 emits ultrasound energy which can then be received either by transducer 102 (in pulse-echo mode) or by any of the other transducers 100-101 or 103-108.

### Data Reduction

The recordings obtained during measuring a single meat specimen (which can be an individual slice of meat, a primal from a carcass, or a cross-section of meat exposed on a carcass, such as during USDA grading of meat) comprise many recordings. These recordings can result from different transducers, or from multiple recordings from the same transducer, and with both pulse-echo and pitch-catch modes, with a total number of recordings that may reach the hundreds or thousands. Each recording can be represented as a time-domain amplitude trace. Because the information related to meat tenderness is roughly encoded in the signal envelopes rather than the signal carrier, the signal envelopes of the recorded traces are generated. This is conveniently performed using Hilbert transforms by conventional signal processing, and the resulting envelope traces are hereafter referred to as envelope functions E(t). Furthermore, because of various types of noise within the signals, both from internal sources of noise (e.g. electronic) and sample variation (e.g. readings taken from different regions within the meat sample), it can beneficial to average the signal from multiple readings (or more generally, to use a measure of central tendency). It should be noted that the averaging can beneficially be performed on the raw data signal, on the envelope traces, or even on the parameters determined below for a given processed trace. If an averaging process is to be performed on the parameters derived by the analyses below, the measure of central tendency can be a median or an average.

The envelope functions are analyzed to generate “reduced parameters”. These reduced parameters relate to four different characteristics of the envelope function.

### Decay of Backscatter Energy

In general, the decay of backscatter energy is related to the tenderness of the meat. This decay can generally be thought to be exponential, in that a roughly constant fraction of the energy is lost at every time interval. However, it should be noted that this exponential decay is not necessarily constant throughout the entire recording from a transducer. For example, the transmission or decay of the signal can be amplitude dependent, in which case the exponential factor can change as the decay changes the amplitude of the sound energy. Alternatively, the backscatter can comprise the sum of multiple components, such that even very energetic backscatter components with very high decays will eventually become small compared with other initially less energetic components with smaller decay rates. All of these and other cases can give rise to backscatter with multiple decay rates.

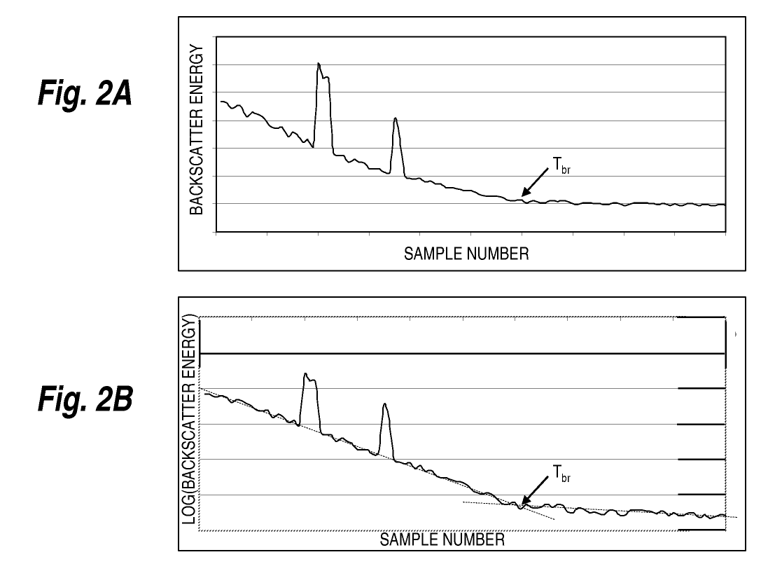

In the prior art of Bond, a single exponential decay constant, D, is used to characterize the gradual loss of energy in the signal, wherein the entire dataset is fit to an exponential curve of the form y=A exp(−Dt), where “t” is the time at which the backscatter energy is received by the transducer. The decay parameter D is called the “unimodal” decay parameter. In the present invention, the signal can be decomposed into early and late exponential curves, each with their own decay parameters, comprising a bimodal envelope function. This can be seen in FIG. 2A, which is a graph of the envelope function for a bimodal envelope function, in which the abscissa is the sample number of the envelope function (or alternatively, the time of recording), and the ordinate is the amplitude of the energy recorded by the transducer. The determination of the reduced parameters related to the bimodal envelope function is described below.

The logarithms of the values of the envelope function are determined. If the original envelope function is an exponential decay, the logarithm of the function will be linear. Because there are two different decay functions, this will form a “broken” line comprised of two different intersecting lines. The point of intersection is called the “break time”, denoted T_{br}. FIG. 2B is the graph of the logarithms of the envelope function depicted in FIG. 2A. The location of the break time is shown in the two figures.

In the present invention, there are two methods of analyzing this bimodal decay. In the first method, the break time is a predetermined time that is the rough average or median time at which the transition from one decay mode to another on a variety of meat samples is observed. Alternatively, the envelope function can be decomposed into three parts: 1) a first part, which provides a “before” decay constant, 2) a second part, which comprises a “buffer” region in which T_{br} is assumed to occur, and 3) a third part, which provides an “after” decay constant. The last sample comprising the first part is preferably less than 0.5 of the total time of the envelope function, and more preferably less than 0.45 of the total time, and most preferably less that 0.4 of the envelope function. The first sample of the third part is preferably more than 0.5 of the total time of the envelope function, more preferably more than 0.55 of the total time, and most preferably more than 0.6 of the total time.

In the second method, the break time is determined for each envelope function. This is done in the following manner. The break time T_{br} is treated as a variable, with a linear regression being performed on the independent line segments on either side of the break point (the fitted linear regression lines are denoted in FIG. 2B as dashed lines). The proper break time for the envelope function is chosen as the point that maximizes a measure of the linear regression fit of the two parts of the envelope function, which is conveniently the sum or the product of the R² correlation coefficients, but which can also be the highest of the minima of the two R² correlation coefficients, or other measure indicating the fitness of the linear regressions.

It should be noted that in performing the linear regression of the envelope function that the noise is not normally distributed. There are excursions from the exponential decay that may be caused by large sound impedance contrasts within the meat, as might occur with, for example, deposits of fat. These excursions will generally result in large reflections of sound energy, and these excursions could affect the goodness of the linear regression fit. In order to account for these excursions, a number of different means can be employed. Among these would be to examine the R correlation coefficient (or other measure of the goodness of fit) in order to determine whether the fit was within a predetermined threshold. If the correlation coefficient is below this threshold, then the data point with the largest positive error (that is, the experimental data is above the fit regression line) is dropped, and the method iterated until the correlation coefficient exceeds the threshold. For this method, it is preferable for the predetermined correlation coefficient threshold to be greater than 0.6, and more preferable for the threshold to be greater than 0.85 and even more preferable for the threshold to be greater than 0.9.

An alternative method of treating these excursions is to approximate the fitted envelope function with a representative “valley” envelope function. It should be noted that the envelope function has significant high frequency content, which is evidenced as peaks and valleys on an amplitude versus time plot. For the valley envelope function, local minima (“valleys”) from the envelope function are chosen, and these are used as the datapoints for further analysis. These data points will generally be used “as is” for fitting to a unimodal or bimodal decay function. Certain of these valley envelope function datapoints can be eliminated as above by virtue of their contributing to high R² correlation coefficients.

The bimodal decay parameters as determined above can be either of two or three values, depending on whether T_{br} is taken as a constant value over all meat samples (and the individual envelope functions for each transducer signal), or whether it is determined separately for each envelope function. In the case of two values, the parameters are then the decay constants for the envelope function from times before the predetermined break time (D_{b}) and for the times after the predetermined break function (Dₐ). In the case of three values, the first two values are those for before (D_{b}) and after the break time (Dₐ), and the third parameter is the break time as determined for each individual envelope function (T_{br}). It should be noted that the unimodal decay constant (Dᵤₙᵢ) as from the prior art can also be used, however this will generally result in less accurate measurements of meat tenderness.

A fourth measure is optionally the ratio of the two decay constants R_{D}=D_{b}/Dₐ. This value can be used in further analysis either as a continuous variable, or alternatively as a binary value (e.g. 1 and 0) depending on the value of R_{D} relative to a predetermined threshold. It should be noted that larger R_{D} values are generally correlated with more tender meat, and the threshold that is used in this determination is preferably greater than or equal to 1.5, and more preferably greater than or equal to 2.0.

As mentioned above, the decay parameters are measured over a large number of traces. To generate the ensemble bimodal decay parameters, the median or average value of the individual parameters can be obtained.

The decay parameters are part of a “fitted envelop function” FE(t), which for an observed bimodal envelope function is specified as:

FE(t)=K_{b}exp(−D_{bt}) t≦T_{br}

FE(t)=Kₐexp(−Dₐt) t>T_{br}

This fitted envelope function can be used as a baseline for further parameter determination, as will be discussed below.

It should be noted that the use of an exponential decay function is convenient given that the decay of sound energy is roughly exponential in nature. However, there are a variety of mathematical functions (including sine/cosine, quadratic or other polynomial, hyperbolic tangent, or algebraic expressions that can comprise linear, non-linear and transcendental functions of time. In such cases, the specific parameters of the function that relate to the relative degree of decay (i.e. monotonically increasing or decreasing with the decay), or combinations of parameters that operate in concert in a similar fashion, can be used instead of the exponential decay factors Dₐ and D_{b} to describe the decay of the envelope function.

A more general way of describing multiple decay rates is that over two periods of similar duration at different times in the envelop function, the fractional decay in energy is different in the two periods. Another method of expressing the decay factors is to determine the fractional decrease in the energy in the envelop function from times A1 to A2, said decrease being F_{A}, and the fractional decrease in the energy in the envelop function from times B1 to B2, said decrease being F_{B}. The times A1 and A2 are both prior to T_{br}, and the times B1 and B2 are both after T_{br}, and while not necessary, the durations A2-A1 and B2-B1 are conveniently equal or similar. The decay ratio R_{D} can be expressed as F_{A}/F_{B}.

### Envelope Quiescence

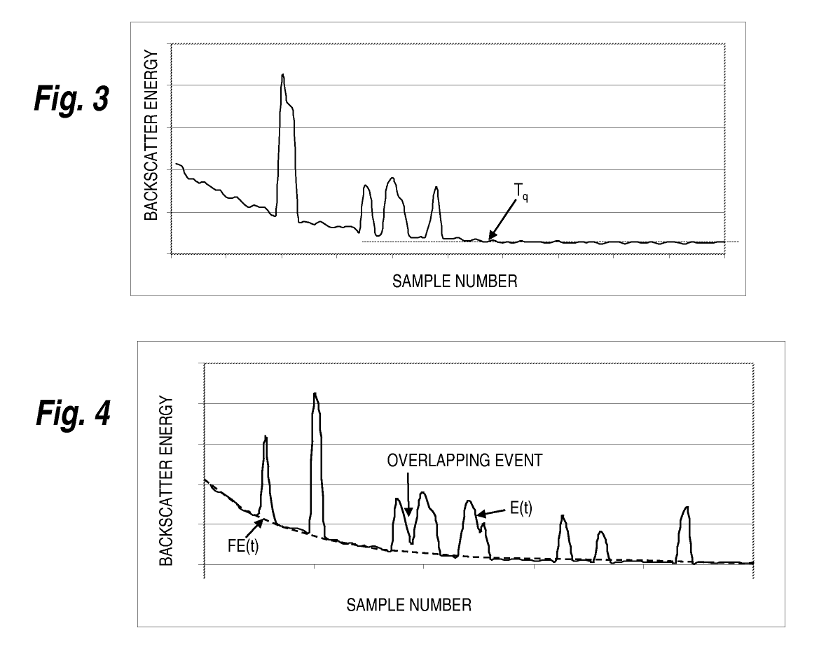

When the meat is tender, there is a tendency for the envelope function to abruptly drop to relatively constant levels, with generally low amplitudes and no events. This is termed envelope “quiescence” that occurs at the quiescence time T_{q}. The presence or absence of this quiescence can be used to indicate meat tenderness in the present invention, where the presence is correlated with increasing tenderness. This is shown in FIG. 3, which is a graph of an envelope function that shows quiescence at the indicated mark.

The quiescence time for an envelope function can be obtained by computing the mean and variance of the samples from a time “t” to the end of the envelope function. The first time at which none of the succeeding samples exceeds a certain predetermined threshold of number of standard deviations from the mean is the T_{q}, where it is preferable for this threshold number of standard deviations to be greater than 6, and more preferable for the number of standard deviations to be 7, and most preferable for the number of standard deviations to be 8. Alternatively, a slight degree of decay can be permitted in the envelop function after the quiescence time, which is taken into account by computing the linear regression of the last samples of the envelop function, and the first time at which none of the succeeding samples exceeds a certain predetermined threshold number of standard deviations from the regression line, similar to those preferable thresholds discussed above, and furthermore, in which the slope of the regression line is less than a predetermined slope threshold, is the T_{q}. It is further within the teachings of the present invention that in addition to the constraint that all samples must fit within a certain number of standard deviations, and a second constraint that the slope of the regression line must be within a certain range, that there can be a third constraint that the mean value of the samples after the quiescence time must be less than a predetermined mean threshold. This predetermined mean threshold is preferably less than 20% of the median amplitude, and more preferably less than 10% of the median amplitude. It should be appreciated that these constraints can be used in isolation of one another, or in combinations of any two or three.

As before, quiescence times are measured for every envelope function. The T_{q}'s of multiple individual envelope functions can be combined in a variety of ways. In a first way, the quiescence time is considered to be significant only if the time occurs before a predetermined threshold time. Times after this are considered a normal result of the decay of energy. Thus, each envelope function can be assigned a binary value of “significant” or “not significant” on the basis of whether the quiescence time occurs before or after the predetermined time threshold. Then, the fraction of the envelope function that is significant (i.e. significant/(significant+not significant)) is then the “quiescence fraction” (F_{q}).

Alternatively, the quiescence times from all of the envelope traces can be computed, and an ensemble value of quiescence time can be computed. This value is conveniently either the average or median value of the quiescence times, or can also be the power mean of the quiescence times to a power K, where the power K is chosen to be >1 in order to emphasize later quiescence times, or <1, in order to emphasize earlier quiescence times. This ensemble quiescence time is then used in later analysis as the ensemble quiescence time T_{enq}.

In one formulation, quiescence is measured as the lack of events (as determined below in the following section) after a threshold time as would be expected from the events computed prior to that threshold time according to a statistical measure. This statistical measure is conveniently the number of events after the threshold time being a number SD of standard deviations lower than that number of events that would be expected based on the events prior to the threshold time, where the number SD is preferably greater than 1, and more preferably greater than 2, and more preferably greater than 3. The quiescence is then expressed either as a binary value (equiescent/not quiescent) related to whether the envelop function was quiescent, given a time T_{br}, or alternatively, expressed as the earliest time T_{br} that exhibits quiescence. Alternatively, quiescence can be expressed as the time of the last event in the envelop function, T_{br}.

The quiescence can be alternatively or additionally expressed by dividing the time T_{br} either by the time period following T_{br}, or alternatively, by the entire time of the envelop function. If the quiescence time is T_{br} and the entire time of the envelope function is Tₜₒₜ, then these measures of the quiescence would be expressed as T_{br}/(Tₜₒₜ−T_{br}) or T_{br}/Tₜₒₜ.

Event Frequency

As discussed before, there are numerous sound impedance contrasts within meat, which are evidenced within the envelope functions as positive excursions from the general decay of sound energy (such as that measured by the bimodal decay parameters). The impedance contrasts can represent interstitial fat within the meat, for example. In general, larger numbers and magnitudes of these events are indicative of tender meat, and can be used within the present invention to improve the accuracy of meat tenderness determination. FIG. 4 is a graph of an envelope function that shows a number of events.

The quantitation of these events must take into account both the frequency of these events as well as the magnitude of the events (e.g. either the height of the event, or the “area” of the event, being a factor of both height and duration). There are a number of different methods of computing event frequency parameters.

In all of these methods, an event determination method is required in order to determine that an event has occurred. The event determination method generally uses the height of the excursion above the fitted envelope function E(t), which is determined in the computation of the unimodal or bimodal decay parameters. An event is generally evidenced by a value that exceeds E(t) by either a predetermined difference threshold (i.e. E(t)−FE(t)>difference threshold), where the value exceeds E(t) by a predetermined ratio threshold (i.e. E(t)/FE(t)>ratio threshold). The difference threshold is preferably greater than or equal to 0.25 of the median envelope amplitude, and more preferably greater than or equal to 0.5 of the median fitted envelope amplitude. The ratio threshold is preferably greater than 1.2, and more preferably greater than 1.5. An event can have duration over a number of time samples, and the extent of an event can be determined to be all those contiguous time samples in which all of the samples meet the criteria above. It should also convenient at times for there to be relaxed parameters for the contiguous samples, since knowing that there is an event at that position, samples that have lesser excursions from the fitted decay curves are still likely to be part of the event. In general, a factor k, where 0<k<1, can be applied by multiplication to the difference or ratio threshold to create a relaxed threshold needed to be met by these contiguous samples to be considered part of the event.

Two events which are very close in time can be overlapping, such as indicated by an event in FIG. 4. In order to account for those events that are overlapping, wherein there is no sample between two events that is not an event, it is within the teachings of the present invention to first gather all of the samples relating to a single event, and then to split the event into a second event when a three- four- or five-point forward or central difference (i.e. local slope) on either side of an interior time sample has first a negative value, and then a positive value, indicating a local minimum. The separation point between the two events is considered to be the sample comprising the local minimum at that location.

It should be noted that the events as computed above can be determined for the entire envelope function, but it is convenient to make said computation over only a first fraction of the envelope function. The reason for this is that large decay parameters and/or short quiescence times can result in a smaller number of events being determined because not enough energy overall is being transmitted to or received from that portion of the meat from which the events are being determined. A convenient time over which to compute such events is either for a predetermined fixed time for each envelope function, or alternatively, a time that is adaptive for each envelope function, and which is conveniently the time break T_{br}. The time over which the events are computed for a particular envelope function is Tₑᵥ.

In the first method of computing the event frequency parameter, the total number of events as computed above, divided by Tₑᵥ is the event frequency parameter. In the second method of computing the event frequency parameter, the total number of samples that are parts of events (that is, a sample whose value E(t) compared by difference or ratio with the FE(t) exceeds the difference or ratio threshold, or the relaxed difference or ratio threshold), divided by Tₑᵥ is the event frequency parameter. It should be noted that Tₑᵥ can be expressed as either an amount of time (e.g. milliseconds), or can alternatively be expressed as a number of samples. In the third method, the total event “area” is computed as the sum of E(t)−FE(t) for the event divided by the Tₑᵥ, wherein the sum can either include both positive and negative excursions, or alternatively where the sum is only computed for those samples in which the excursion is positive (i.e. FE(t)>E(t)). The parameter so determined is considered as a frequency, having in the denominator the time Tₑᵥ, and is called the event frequency Fₑᵥ.

A second parameter related to event frequency is the fraction of sound energy that is related to events relative to the background decay, or otherwise stated as the total event area over the area of the fitted envelope function. This parameter, Aₑᵥ, is computed as (E(t)−EF(t))/EF(t).

Event Asymmetry

In general, envelope functions that are more asymmetrical are more indicative of meat that is tender. More specifically, events associated with meat tenderness are more likely to have a fast rise, and a slow decay, and can be used within the present invention to improve the accuracy of meat tenderness measurement. Such events are shown in FIG. 5, which is a graph of an envelope function that shows a number of asymmetrical events. The determination of event asymmetry generally is preceded by the determination of an event, such as by one of the means described above in the determination of event frequency Fₑᵥ. The asymmetry can then be noted by a number of different methods, of which two are described below.

In the first method, the position of the peak is measured relative to the first and last samples in the peak in which the sample fits the given threshold for being part of an event. The number of samples (or similarly, the amount of time) before the peak is given by N_{b}, while the number of samples after the peak is given by Nₐ. The asymmetry in this case can be computed either by the ratio of “after” to “before” samples (i.e. Nₐ/N_{b}), or alternatively, as the ratio of after to total samples (i.e. Nₐ/(Nₐ+N_{b})). If the given ratio exceeds a predetermined threshold, the event is considered to be an asymmetrical event, wherein the threshold is preferably greater than or equal to 1.5, and more preferably greater than or equal to 2. In the case that the peak of the event extends over a number of samples (e.g. by virtue of the two- or three-point difference slope of the peak of the event, or by methods described below), N_{b} will include those samples from the beginning of the event until the first sample of the peak of the event, while Nₐ will include those samples from the least sample of the peak of the event until the last sample of the event.

In the second method, the position of the peak is measured relative to the exponential rise and exponential drop of energy within an event. For this method of measurement of asymmetry, the exponential rise rate constant Rᵣᵢₛₑ and the exponential decay rate constant R_{fall} are computed relative to the peak of the event. In the case that the peak of the event is determined to extend over a number of samples (e.g. by the fact that the samples do not fit into either exponential rise or exponential decay functions, as described below), Rᵣᵢₛₑ is computed relative to the first sample of the peak, and R_{fall} is computed relative to the least sample of the peak. R_{fall} is computed as usual for exponential decay, by fitting the logarithm of the samples versus time to a line, such as by linear regression, represented for example by the equation E(t)=Aexp(−R_{fall}(t−Tₚₑₐₖ)). To compute Rᵣᵢₛₑ, the same process is used from the beginning of the event by fitting to the equation E(t)=Aexp(Rᵣᵢₛₑ(T−T_{begin})), where T_{begin} is the first sample in the event. Because of the equations used, both Rᵣᵢₛₑ and R_{fall} are positive constants. The event can be considered to be asymmetrical if the ratio of Rᵣᵢₛₑ to R_{fall} (i.e. Rᵣᵢₛₑ/R_{fall}) exceeds a predetermined threshold, wherein the threshold is preferably greater than or equal to 1.5, and more preferably greater than or equal to 2.

In a third method, the area of the event either before or after the peak can be computed as Aᵣᵢₛₑ and A_{fall}, and the ratio of the area before or after the fall A_{fall}/Aᵣᵢₛₑ (or some similar indication of their relative magnitude) computed. If the ratio exceeds a predetermined threshold, the event is considered to be asymmetrical, wherein the threshold is preferably greater than or equal to 1.5, and more preferably greater than or equal to 2.

In general, there will be a number of events in a given envelope function, and the asymmetry index for the envelope function can be determined as the fraction of events (or a power of the fraction of events) that are determined by one of the methods above, or other methods, to be asymmetrical. It should be appreciated that some events are larger than others, and it is also convenient in determining the fraction of events that are asymmetrical within an envelope function to weigh each event on the basis of the area under the event, as described above (e.g. the area determined by either the number of samples over which the event occurs, or alternatively by the difference between the envelope function E(t) and the fitted envelope function (FE(t)).

It should also be appreciated that the methods above operate by assigning each event to be either of the two binary values—symmetrical or asymmetrical. It can alternatively be convenient to assign each event to be a continuous value, wherein, for example, a perfectly symmetrical event has the value 0, and increasing values indicate an increasing degree of asymmetry with slower decay after the peak (it is also possible within this framework to have asymmetry of the form that the rise is slower than the decay, which would be represented as a negative value). In such case, the asymmetry of the entire envelope function can be represented as a mean or median value (which may be weighted, as described above, in terms of the size of the event, which can be further adjusted by the use of a power mean computation, which can emphasize or de-emphasize events of larger or smaller excursions from the mean through adjustment of the exponent of the power mean). This mean or median value can be assigned as a continuous function to the envelope function, or alternatively, if this value exceeds a predetermined value, then the entire envelope function can be assigned as asymmetrical, and otherwise as symmetrical.

There are a large number of envelope functions for a particular sample of meat, and the ensemble of envelope functions can be assigned a value as either the mean or median of the individual values of the traces. This value is considered the asymmetry index (I_{asy}).

### Treatment of Envelope Ensembles

As described above, there are four general classes of envelope parameters than can be determined, including:

Decay parameters (Dₐ, D_{b}, T_{br}, R_{D})

Quiescence parameters (T_{enq}, F_{q})

Event frequency parameters (Fₑᵥ, Aₑᵥ)

Event asymmetry parameters (I_{asy})

The last step in the computation of each of these parameters is consolidating the values of the parameters from individual envelope functions over the ensemble of envelop functions. As described above, this is typical performed by some sort of mean or average value of each of the individual envelop functions.

It is also convenient to compute one or more values that represent the spread of the values over the individual envelop functions. For example, for median scores, the values of various percentiles other than the 50^{th} percentile can be scored, with computation of the 25^{th} and 75^{th} percentile values (or the 20^{th} and 80^{th} percentile values) being convenient. Alternatively, for mean scores, the variance of the values over the ensemble of traces can be computed.

Other Parameters

As mentioned above, there are a number of other parameters that can be compiled that are related to the animal for which the tenderness is being measured. These parameters can include the age, gender and breed of the animal, the physical characteristics of the animal (e.g. body-mass index, grade and yield), as well as descriptions of the ways in which the meat has been prepared (e.g. length of aging, temperature of aging, etc.). These parameters can include continuous values (e.g. age of animal, body-mass index), as well as nominal values (Brahmin, Angus). Collectively, these parameters are denoted as “non-envelope parameters”, as they are independent of the envelope functions.

A further parameter of the envelope function of value is the total amount of reflected energy (i.e. the area under the envelope function). This value comprises to some extent a combination of different effects, including the decay parameter (stronger decay yields less overall energy), the number of events (more events results in more energy), quiescence (earlier quiescence results in lower energy) and more, but can have independent value as well.

### Decision Making

To this point, a number of parameters related to both the envelope functions, as well as non-envelope parameters have been obtained. Roughly speaking, the tenderness of the meat is related by a function of these parameters. The tenderness can be expressed as a continuous value called a “tenderness score”, which can be related to the pounds of shear obtained from the Warner-Bratzler Shear test. Alternatively, this can be used to generate a nominal classification of the meat, such as the current grading system (Prime, Choice, Select, etc.) called a “tenderness grade”.

The methods used in generating the tenderness score or tenderness grade are similar. The scores and grades are generated by a decision algorithm, which conveniently comprises one of:
a Baysian classifier, such as the naïve Bayes classifier (George H. John and Pat Langley (1995). Estimating Continuous Distributions in Bayesian Classifiers. Proceedings of the Eleventh Conference on Uncertainty in Artificial Intelligence. pp. 338-345. Morgan Kaufmann, San Mateo.)
A neural network, such as a multilayer backpropagation network, or a radial basis function network, or a support vector machine
A multiple linear, quadratic, exponential or other regression
An instance-based classifier (e.g. Kstar—John, G. Cleary and Leonard, E. Trigg (1995) “K*: An Instance-based Learner Using an Entropic Distance Measure”, Proceedings of the 12th International Conference on Machine learning, pp. 108-114.)
Decision trees (e.g. Ross Quinlan (1993). “C4.5: Programs for Machine Learning”, Morgan Kaufmann Publishers, San Mateo, Calif., or N. Landwehr, M. Hall, E. Frank ‘Logistic Model Trees’ (ECML 2003)).
Rule learners (e.g. decision tables, as in Kohavi R. (1995). “The Power of Decision Tables.” In Proc European Conference on Machine Learning, or the M5 rule learner described in M. Hall, G. Holmes, E. Frank (1999). “Generating Rule Sets from Model Trees”. Proceedings of the Twelfth Australian Joint Conference on Artificial Intelligence, Sydney, Australia. Springer-Verlag, pp. 1-12.).
Fuzzy logic classifiers (e.g. “Fuzzy Logic and NeuroFuzzy Applications Explained”, Constantin Von Altrock (1995), Prentiss Hall, Englewood Cliffs, N.J.).

This process can be described mathematically as [score,grade]=DA[decay parameters, quiescence parameters, event frequency parameters, event asymmetry parameters, non-envelope parameters], where DA is the decision algorithm function.

It should be noted that there are a number of “meta” decision algorithms that comprise multiple individual decision algorithms, often with one decision algorithm operating on another decision algorithm. Examples of these meta-decision algorithms include the AdaBoost method (Yoav Freund and Robert E. Schapire (1996). “Experiments with a new boosting algorithm”. Proc International Conference on Machine Learning, pages 148-156, Morgan Kaufmann, San Francisco), LogitBoost (Friedman, J., T. Hastie and R. Tibshirani (1998) “Additive Logistic Regression: a Statistical View of Boosting”. Technical report. Stanford University.), metaCost (Friedman, J., T. Hastie and R. Tibshirani (1998) “Additive Logistic Regression: a Statistical View of Boosting”. Technical report. Stanford University.) and others.

The success of these decision algorithms is increased by the numbers of examples of known values. However, as the number of input parameters increases, so does the number of known examples required for determining the optimal algorithm parameters. The tenderness score or tenderness grade is generally determined by reference to the score resulting from the WBS test. If a tenderness grade is required, this is generally related to the WBS test—e.g. that the select/choice classification boundary is assigned to a particular value, such as 9 lbs of shear.

The decision algorithm is “trained” on a number of known inputs and outputs, wherein the number is preferably over 1000, and even more preferably over 2000 meat samples, wherein the samples are taken from distinct animals, and furthermore, that the samples are chosen from a range of different animal breeds, ages, and meat tenderness, so that the algorithm has a chance to “sample” a variety of types of meat that might be encountered in an operation.

Each envelope parameter described above comprises information related to the tenderness of the meat, and as such, can be used independently of the other parameters in the decision algorithm. However, it is a teaching of the present invention that the accuracy of the tenderness measurement is improved by the use of multiple envelope parameters in the decision algorithm, and that the accuracy of the use of two parameters is better that with a single envelope parameter, and that the accuracy of three parameters is better than with the use of two parameters, and that the accuracy of all four parameters is better than the accuracy with three parameters. It is further a teaching of the present invention that while the use of a unimodal decay parameter can result in a useful measurement of the meat tenderness, the use of bimodal decay parameters results in increased accuracy, with the advantages attendant thereto.

It should be noted that traditional decision algorithms are linear with respect to the input parameters—that is, that more of a “positive” parameters yields better tenderness, as does less of a “negative” parameter. If the input parameters are P₁, P₂ . . . Pₙ, then the resulting tenderness X would be expressed as some linear combination of these parameter values (i.e. X=a₁P₁+a₂P₂+ . . . +aₙPₙ). It should be noted that while such a linear combination of envelop parameters as described hereinabove can yield a useful measurement of tenderness, the use of non-linear decisional algorithms yield a decidedly better accuracy in tenderness estimation.

It is preferable that the decision algorithm be chosen so that either the accuracy of the tenderness score or the tenderness grade exceeds a predetermined value. In the case of the tenderness grade, a false-positive grade (i.e. a piece of meat is graded tender, when it is actually tough) is more problematic than a false-negative grade (i.e. a piece of meat is graded tough, when it is actually tender), since one purpose of the present invention is to allow meat packers or retail operations to guarantee the tenderness of the meat, and a false-positive grade results in a failure of the guarantee, whereas a false-negative grade does not. It is preferable for the decision algorithm to be chosen so that the fraction of false-positive grades to be less than 10%, and more preferable for the fraction of false-positive grades to be less than 3%, and most preferable for the fraction of false-positive grades to be less than 1%.

In general, the fraction of false-positive grades can be minimized by increasing the number of false-negative grades. This, however, increases the number of meat samples that are incorrectly graded tough, which reduced the economic benefits that would accrue should the meat be properly graded. The ratio of false-negative to false-positive grades is therefore a significant factor in the selection of a decision algorithm, and it is preferable for this ratio to be less than 5, and more preferable for this ratio to be less than 3 and most preferable for this ratio to be less than 2.

In the cases where a tenderness score instead of a tenderness grade is desired, the accuracy can be measured in a variety of different ways. In general, for every meat sample, there will be a tenderness score from operation of the present invention, and the “real” tenderness, as measured, for example, by the Warner-Bratzler Shear test. Any such test will have, it should be noted, a statistical variation both due to measurement errors, as well as local variations in the meat (e.g. the WBS test is performed on one sample from a given carcass, and the present invention applied to a different sample from the same carcass). Using the terminology of “real” measurements to indicate those tenderness measurements resulting from an external standard (e.g. WBS) and “test” measurements to indicate those tenderness measurements resulting from the present invention, measures of accuracy of tenderness scores include:
the sum of the differences between real and test measurements, divided by the sum of the real measurements;
the sum of the absolute differences between real and test measurements, divided by the sum of the real measurements,
the power mean of the differences between real and test measurements, divided by the sum of the real measurements, wherein the exponent of the power mean is conveniently 2 (i.e. root mean square)
any of the measures above, wherein the positive differences (i.e. where the present invention overestimates the tenderness of the meat)

It is further a teaching of the present invention that the event frequency parameter indicates the amounts of interstitial fat deposits within the meat, and that this information can be used as a means of estimating the marbling of fat within the meat.

It should be understood that while the description above relates the present invention to the tenderness of beef, it is also applicable to other meats as well, including pork, lamb, buffalo, and other meat animals. It is further anticipated that the present invention will be related to fish, whether for use in cooked foods, or in uncooked foods (e.g. sushi).

It is further anticipated that the methods of the present invention will be applicable to medical uses outside of their use for the determination of meat tenderness. It is well-known that disease and aging causes physiological differences in human muscle (e.g. Deschenes M R. “Effects of aging on muscle fibre type and size.”, Sports Med. 2004; 34(12):809-24; Laing N G, Nowak K J. “When contractile proteins go bad: the sarcomere and skeletal muscle disease.” Bioessays. 2005 August; 27(8):809-22.). Conventional ultrasound imaging does not have the necessary resolution to discern changes in the muscle that occur at the muscle fiber level, and conventional electromyograms provide indications about physiological conditions of the muscle, but not about structural or ultrastructural conditions. The use of the present invention to medical applications is, obviously, not for direct application to measuring “tenderness” of human muscle, but inasmuch as the parameters listed above relate to aspects of muscle structure that indirectly affect tenderness in meat animals, their use in medical diagnosis is practical.

In its application to medical uses, ultrasound backscatter energy is recorded with methods similar to that above. Recordings will generally be performed on larger muscle masses such as the biceps, the triceps, the gluteus maximus, and the gastrocnemius. These masses, however, (with the possible exception of the gluteus maximus) do not present as flat and large a surface for the recording as the surface used in determining meat tenderness. For this reason, the ultrasound transducers can be arranged relative to the assembly in a different manner than that used in meat tenderness. One difference will be, in general, that the number of transducers in the assembly will be smaller, with a number preferably greater than 3, more preferably greater than 5 and most preferably greater than 7. In addition, because the body surface over the muscle is not flat, the surface of the assembly can be curved to accommodate body curvature. The transducers can be oriented so as to be normal to this assembly surface, or can alternatively be oriented so that all of the transducers in the assembly are parallel to one another. Furthermore, because the muscle fibers are generally parallel to the skin, transducers placed normal to the skin will be well positioned with respect to the muscle fibers. Therefore, the orientation of the transducers with respect to the surface of the assembly will be different from that used for meat tenderness.

After recording, the envelope functions are prepared as above, and parameters similar to those above are computed, including the parameters of unimodal or bimodal decay, of quiescence, of event frequency, and of event asymmetry. Additional information regarding the medical history of the patient are determined, which parameters can comprise:
age,
gender,
muscle type (e.g. biceps),
muscle tone at the time of recording (for example, the recording can be made with the muscle relaxed or in tension, which can be controlled either voluntarily by the patient, or alternatively under control of an external electrical stimulus).
Body-mass index of the patient

As described above, a decision algorithm is obtained by relating these parameters to other parameters of patient physiology, such as strength, known physiological diseases (e.g. sacropenia, intramuscular myxoma, and general atrophying diseases), and genetic abnormalities (e.g. congenital fiber type disproportion, inclusion body myopathy, hyaline body myopathy, myofibrillar myopathy, nemaline myopathy, and autosomal recessive limb-girdle muscular dystrophy). In general, the output of the decision algorithm will be related to classification (similar to grading) rather than scoring, as a diagnostic result is desired. In this case, false-negative classifications are of particular importance, since these represent people with muscle dysfunction that are not properly diagnosed, so care is taken to reduce these classifications as much as possible.

### Many Embodiments Within the Spirit of the Present Invention

It should be apparent to one skilled in the art that the above-mentioned embodiments are merely illustrations of a few of the many possible specific embodiments of the present invention. It should also be appreciated that the methods of the present invention provide a nearly uncountable number of arrangements.

Numerous and varied other arrangements can be readily devised by those skilled in the art without departing from the spirit and scope of the invention. Moreover, all statements herein reciting principles, aspects and embodiments of the present invention, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

In the specification hereof any element expressed as a means for performing a specified function is intended to encompass any way of performing that function. The invention as defined by such specification resides in the fact that the functionalities provided by the various recited means are combined and brought together in the manner which the specification calls for. Applicant thus regards any means which can provide those functionalities as equivalent as those shown herein.

What is claimed is:

1. A method for determining meat tenderness from the envelope function of a backscattered energy signal of an ultrasound transducer coupled to meat fibers, comprising:
determining a first decay parameter from an initial portion of the envelope function;
determining a second decay parameter from a later portion of the envelope function;
computing a bimodal decay parameter from the first decay parameter and the second decay parameter; and
relating the bimodal decay parameter to the tenderness of the meat.

2. The method of claim 1 wherein the first decay parameter is a parameter of an exponential decay function.

3. The method of claim 1 wherein the second decay parameter is a parameter of an exponential decay function.

4. The method of claim 1 wherein the bimodal decay parameter comprises the ratio of the first decay parameter and the second decay parameter.

5. The method of claim 1 wherein the first portion and the second portion intersect substantially at a break time, and wherein the break time is related to the tenderness of the meat.

6. A method for determining meat tenderness from the envelope function of a backscattered energy signal of an ultrasound transducer coupled to meat fibers, comprising:
determining a quiescence time as the first time after which the envelope function exhibits at least one envelope feature chosen from the set of no events, an amplitude that does not exceed a value that is a calculating function of the amplitude over the time prior to the quiescence time, and a linear regression slope below a predetermined value; and
relating the quiescence factor to the tenderness of the meat.

7. The method of claim 6 wherein the calculating function is a predetermined fraction of the central tendency of the amplitude of the envelope function, wherein central tendency is taken from the set consisting of mean and median.

8. The method of claim 6 wherein the calculating function is a predetermined number of standard deviations from the mean amplitude of the samples following the quiescence time.

9. The method of claim 6 wherein the calculating function is a predetermined number of standard deviations from a linear regression of the samples after the quiescence time.

10. The method of claim 6 wherein relating involves two or more envelope features.

11. The method of claim 6 wherein an event is identified as a set of contiguous samples in which the amplitude of the sample exceeds the fitted envelope function by a predetermined fraction of the fitted envelope function from an operation selected from the set consisting of the difference and the quotient, and wherein the fitted envelope function is computed as a regression fit of the envelope function to a unimodal or bimodal decay function.

12. A method for determining meat tenderness from the envelope function of a backscattered energy signal of an ultrasound transducer coupled to meat fibers, comprising:
computing a fitted envelop function;
identifying events as amplitudes in excess of the fitted envelope function that meet a predetermined criterion;
determining at least one feature of the events selected from the set consisting of the number of events per unit time, the average amplitude of the events, the fraction of samples during which events occur, and the ratio of the amplitude within all events to the area of the fitted envelope function; and
relating the feature to the tenderness of the meat.

13. The method of claim 12 wherein the fitted envelope function is computed by regression of the local minimum values of the envelope function to a monotonically decreasing function.

14. The method of claim 13 wherein the monotonically decreasing function is a function selected from the set consisting of unimodal and bimodal exponential decay.

15. A method for determining meat tenderness from the envelope function of a backscattered energy signal of an ultrasound transducer coupled to meat fibers, comprising:
computing a fitted envelop function;
identifying events as amplitudes in excess of the fitted envelope function that meet a predetermined criterion;
determining an asymmetry index of the events; and
relating the asymmetry to the tenderness of the meat.

16. The method of claim 15 wherein the asymmetry index is determined for each event by computing a ratio of a first number of samples in the event prior to the maximum value of the event to a second number of samples in the event subsequent to the maximum value of the event, and then subsequently computing for all events in the envelope function a measure of the central tendency for this ratio selected from the set consisting of the mean and the median.

17. The method of claim 15 wherein the asymmetry index is determined for each event by computing a ratio of the first amplitude of the event prior to the maximum value of the event to a second amplitude of the event subsequent to the maximum value of the event, and then subsequently computing for all events in the envelope function a measure of the central tendency for this ratio selected from the set consisting of the mean and the median.

18. The method of claim 15 wherein the asymmetry index is determined for each event by computing the ratio of a first exponential decay constant for the event prior to the maximum value of the event to a second exponential decay constant for the event subsequent to the maximum value of the event, and then subsequently computing for all events in the envelope function a measure of the central tendency for this ratio selected from the set consisting of the mean and the median.

19. A method for determining meat tenderness from the envelope function of a backscattered energy signal of an ultrasound transducer coupled to meat fibers, comprising:
determining at least two of the features selected from the set consisting of a bimodal decay parameter, a quiescence time, an event frequency parameter, and an event asymmetry index; and
relating the features to the tenderness of the meat.

20. The method of claim 19, wherein the relating is performed by at least one decision algorithm chosen from the set selected from neural network, a fuzzy logic classifier, a Bayesian classifier, a regression, an instance-based classifier, a decision tree, or a learned rule.

21. The method of claim 19, wherein the relating produces a classification of the meat tenderness.

22. The method of claim 19, wherein the relating produces a numerical score indicating the meat tenderness.

23. The method of claim 19, further including a step of relating the features to the amount of fat deposits in the meat.

24. The method of claim 19, wherein the relating further uses an extrinsic feature of the animal selected from the set consisting of the age, the gender, the breed, the body-mass index, the quality grade, the yield, the length of meat aging, and the temperature of aging.

25. A method for determining meat tenderness from the envelope function of a backscattered energy signal of an ultrasound transducer coupled to meat fibers, comprising:
determining at least two of the features selected from the set consisting of a unimodal decay constant, a bimodal decay constant, a quiescence factor, an event frequency parameter, and an event asymmetry index; and
relating the features to the tenderness of the meat using a non-linear decision algorithm.

26. The method of claim 25, wherein the relating is performed by at least one decision algorithm chosen from the set selected from neural network, a fuzzy logic classifier, a Bayesian classifier, a regression, an instance-based classifier, a decision tree, or a learned rule.

27. A method for determining meat tenderness from the envelope function of a backscattered energy signal of an ultrasound transducer coupled to meat fibers, comprising:
computing a fitted envelope function to the local minimum values of the envelope function;
relating the fitted envelope function to the tenderness.

28. The method of claim 27 wherein the fitted envelope function is a function selected from the set consisting of bimodal exponential decay function and unimodal exponential decay function.

29. The method of claim 27 wherein the computation is performed by cyclical regression, wherein the samples that are more than a predetermined number of standard deviations from the regression curve are removed from the envelope function, and the regression is repeated.

30. The method of claim 27 wherein the computation is performed by cyclical regression, wherein the samples that are more than a predetermined ratio above the regression curve are removed from the envelope function, and the regression is repeated.

31. A method for determining an aspect of muscle physiology of a live organism, comprising:
coupling an ultrasound transducer to skin overlying a muscle;
transducing energy into the muscle from the transducer;
receiving the backscattered energy into the transducer;
converting the backscattered energy to a envelope function;
computing a fitted envelope function from the envelope function;
determining from the envelope function and the fitted energy function at least one feature selected from the set consisting of a bimodal decay constant, a quiescence factor, an event frequency parameter, and an event asymmetry index; and
relating the features to the physiology of the muscle.

32. The method of claim 31 wherein the physiology of the muscle comprises a disease state selected from the set consisting of sacropenia, intramuscular myxoma, congenital fiber type disproportion, inclusion body myopathy, hyaline body myopathy, myofibrillar myopathy, nemaline myopathy, and autosomal recessive limb-girdle muscular dystrophy.

33. The method of claim 31 wherein the fitted envelope function is a function selected from the set consisting of bimodal exponential decay function and unimodal exponential decay function.
